(19) United States
(12) Patent Application Publication
(10) Pub. No.: US 2020/0244110 A1
(43) Pub. Date: Jul. 30, 2020

(54) WIRELESS POWER FEEDER SYSTEM

(71) Applicants: Kabushiki Kaisha Toshiba, Tokyo (JP); Toshiba Electronic Devices & Storage Corporation, Tokyo (JP)

(72) Inventor: Kazuhiro Nakagawa, Kawagoe Saitama (JP)

(21) Appl. No.: 16/537,825

(22) Filed: Aug. 12, 2019

(30) Foreign Application Priority Data
Jan. 29, 2019 (JP) 2019-012910

(51) Int. Cl. H02J 50/60; H02J 50/12

(52) U.S. Cl. CPC H02J 50/60; H02J 50/12

(57) ABSTRACT

According to an embodiment, a wireless power feeder system includes a power transmission circuit and an object detection circuit. The power transmission circuit includes a power transmission coil and a condenser, and forms a serial resonance circuit to feed power to an object during a wireless power feeding mode to wirelessly feed power to the object, and forms a parallel resonance circuit during an object determination mode. The object detection circuit includes a detection circuit and a determination circuit, operates during the object determination mode by supplying an applied voltage to the power transmission coil, and determines an object.

### CROSS REFERENCE TO RELATED APPLICATION

This application is based upon and claims the benefit of priority from the prior Japanese Patent Application No. 2019-012910, filed on Jan. 29, 2019, the entire contents of which are incorporated herein by reference.

### FIELD

The embodiments described herein relate to a wireless power feeder system.

### BACKGROUND

In recent years, many wireless power feeder systems to wirelessly feed power from a power transmission side to a power reception side have been developed for consumer devices, industrial devices, and the like. In power feeding by wireless power feeder systems, it is very important to determine an object on the power reception side set close to a power transmission coil on the power transmission side and feed suitable power to the object.

The object determination uses resonance frequency and requires a circuit design that takes overvoltage and overcurrent into consideration to avoid circuit breakage. Hence, there is a problem that the system development and the evaluation process require a long period of time.

Meanwhile, there is a method using the Q factor for object determination, but it is difficult to determine an object only with the Q factor. Hence, there is a problem that an object that is actually chargeable may possibly be erroneously determined as unchargeable for safety, which lowers convenience.

### BRIEF DESCRIPTION OF THE DRAWINGS

FIG. 1 is a circuit diagram illustrating a wireless power feeder system according to a first embodiment;

FIG. 2 is a circuit diagram illustrating a driver according to the first embodiment;

FIG. 3 is a diagram illustrating a wireless power feeding mode according to the first embodiment;

FIG. 4 is a diagram explaining states in the wireless power feeding mode according to the first embodiment;

FIG. 5 is a diagram illustrating an object determination mode according to the first embodiment;

FIG. 6 is a diagram explaining a state in the object determination mode according to the first embodiment;

FIG. 7 is a diagram explaining a two-dimensional coordinate representation of an object according to the first embodiment;

FIG. 8 is a diagram explaining the resonance frequencies and peak voltages of objects relative to references according to the first embodiment;

FIG. 9 is a flowchart illustrating a process of acquiring reference data according to the first embodiment;

FIG. 10 is a flowchart illustrating a process of detecting an object according to the first embodiment;

FIG. 11 is a flowchart illustrating a process of feeding power to an object according to the first embodiment;

FIG. 12 is a circuit diagram illustrating a wireless power feeder system according to a second embodiment;

FIG. 13 is a diagram illustrating a relation between applied voltage and peak voltage according to the second embodiment; and

FIG. 14 is a flowchart illustrating a process of detecting an object according to the second embodiment.

### DETAILED DESCRIPTION

According to an embodiment, a wireless power feeder system includes a power transmission circuit and an object detection circuit. The power transmission circuit includes a power transmission coil and a condenser, and forms a serial resonance circuit to feed power to an object during a wireless power feeding mode to wirelessly feed power to the object, and forms a parallel resonance circuit during an object determination mode. The object detection circuit includes a detection circuit and a determination circuit; and operates during the object determination mode by supplying an applied voltage to the power transmission coil. The detection circuit receives a detected signal outputted from the power transmission coil, calculates a peak voltage and a resonance frequency by scanning voltage and frequency of the detected signal, and classifies information on the peak voltage and the resonance frequency into one of a plurality of regions. The determination circuit determines the object by comparing information on a reference state where nothing is set close to the power transmission coil and the information on the peak voltage and the resonance frequency classified with the object.

Further embodiments will be described below with reference to the drawings. Throughout the drawings, identical reference signs designate identical or similar portions.

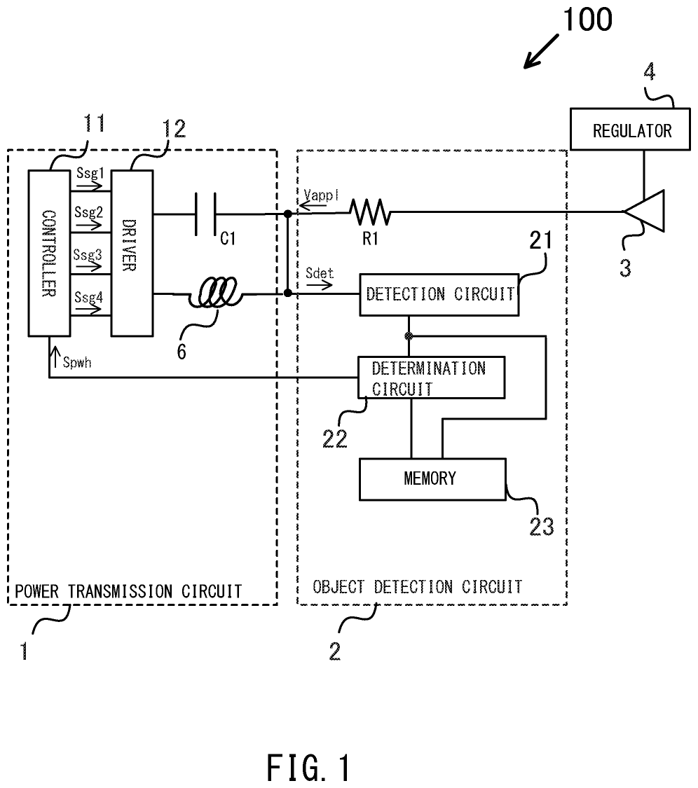

A wireless power feeder system according to a first embodiment will be described with reference to drawings. FIG. 1 is a circuit diagram illustrating the wireless power feeder system.

In the first embodiment, in a wireless power feeding mode, a power transmission circuit forms a serial resonance circuit to transmit a power signal to an object on the power reception side. In an object determination mode, the power transmission circuit forms a parallel resonance circuit, and an applied voltage is supplied to a power transmission coil in the parallel resonance circuit from an AC signal generator through a resistor. As the applied voltage is supplied to the power transmission coil, the object detection circuit classifies and determines the object on the basis of a detected signal detected from the power transmission coil in the parallel resonance circuit.

As illustrated in FIG. 1, a wireless power feeder system 100 includes a power transmission circuit 1, an object detection circuit 2, an AC signal generator 3, and a regulator 4. The wireless power feeder system 100 is for indoor and outdoor use and is used in a consumer device, an industrial device, or the like. The wireless power feeder system 100 has the wireless power feeding mode and the object determination mode.

The object includes a receiver with a power reception circuit, or a metallic object. The receiver is provided in a sensor device, a mobile device, a wearable device, a household device, a robot, a power infrastructure system, or the like, for example.

The power transmission circuit 1 includes a coil 6, a controller 11, a driver 12, and a condenser C1. In the wireless power feeding mode, the power transmission circuit 1 feeds power to an object on the power reception side. The coil 6 functions as a power transmission coil. The power transmission circuit 1 is provided in a base station or the like, for example.

The controller 11 generates control signals Ssg1 to Ssg4 and outputs the control signals Ssg1 to Ssg4 to the driver 12. The controller 11 receives a power change signal Spwh transmitted from the object detection circuit 2, and changes a condition for the power to be fed on the basis of the power change signal Spwh to select a suitable power condition for the object (details will be described later).

The coil 6 (power transmission coil) includes one end connected to one end of the condenser C1. The coil 6 (power transmission coil) and the condenser C1 form a resonance circuit.

The driver 12 receives the control signals Ssg1 to Ssg4, outputted from the controller 11, and changes the circuit configuration of the resonance circuit formed of the coil 6 and the condenser C1 on the basis of the control signals Ssg1 to Ssg4 to thereby set or change the condition for the power to be fed.

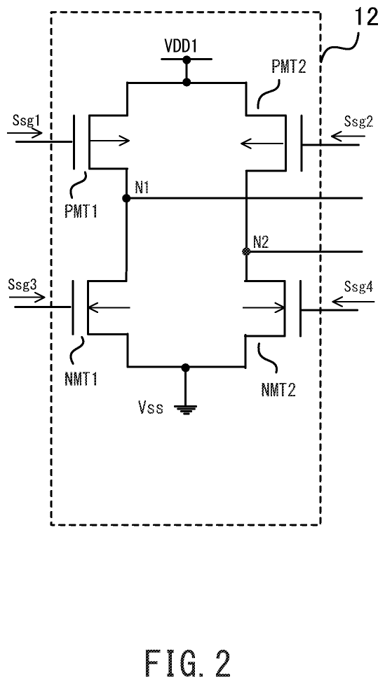

FIG. 2 is a circuit diagram illustrating the driver 12. The driver 12 includes a P-channel MOS transistor PMT1, a P-channel MOS transistor PMT2, an N-channel MOS transistor NMT1, and an N-channel. MOS transistor NMT2. The driver 12 is also called a full bridge circuit or an H-bridge circuit.

The P-channel MOS transistor PMT1 (first transistor) includes one end (source) connected to a power supply VDD1, other end (drain) connected to a node N1 and the condenser C1, and a control terminal (gate) to receive the control signal Ssg1 (first control signal). A power supply voltage is supplied to the P-channel MOS transistor PMT1 from the power supply VDD1, and the P-channel MOS transistor PMT1 is turned on when the control signal Ssg1 is in an enable state (low level).

The P-channel MOS transistor PMT2 (second transistor) includes one end (source) connected to the power supply VDD1, other end (drain) connected to a node N2 and the coil 6, and a control terminal (gate) to receive the control signal Ssg2 (second control signal). The power supply voltage is supplied to the P-channel MOS transistor PMT2 from the power supply VDD1, and the P-channel MOS transistor PMT2 is turned on when the control signal Ssg2 is in an enable state (low level).

The N-channel MOS transistor NMT1 (third transistor) includes one end (drain) connected to the node N1 (the other end of the P-channel MOS transistor PMT1), other end (source) connected to a ground potential Vss, and a control terminal (gate) to receive the control signal Ssg3 (third control signal). The N-channel MOS transistor NMT1 is turned on when the control signal Ssg3 is in an enable state (high level).

The N-channel MOS transistor NMT2 (fourth transistor) includes one end (drain) connected to the node N2 (the other end of the P-channel MOS transistor PMT2), other end (source) connected to the ground potential Vss, and a control terminal (gate) to receive the control signal Ssg4 (fourth control signal). The N-channel MOS transistor NMT2 is turned on when the control signal Ssg4 is in an enable state (high level).

Here, the driver 12 is formed of P-channel MOS transistors and N-channel MOS transistors but the configuration does not necessarily have to be limited to the above case. The driver 12 may be formed solely of N-channel MOS transistors, for example. In this case, it is preferable that the enable state of each of the control signals Ssg1 and Ssg2 be a high level.

The object detection circuit 2 includes a detection circuit 21, a determination circuit 22, a memory 23, and a resistor R1. The detection circuit 21, the determination circuit 22, and the memory 23 are provided in a microcontroller, for example. The object detection circuit 2 operates during the object determination mode. Note that the AC signal generator 3 and the regulator 4 may be provided in the object detection circuit 2.

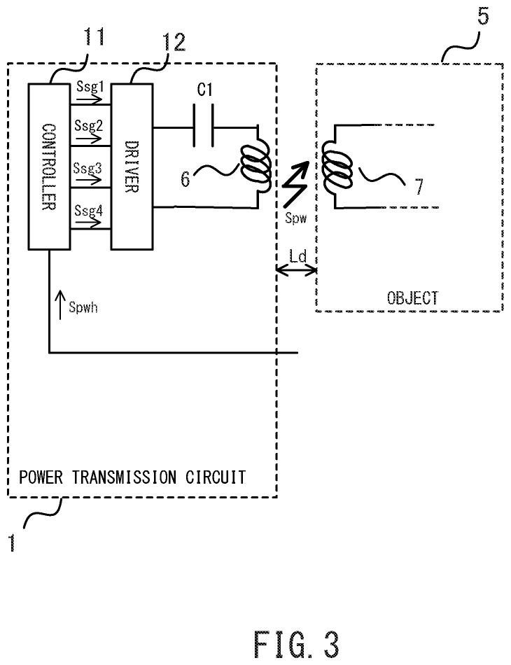

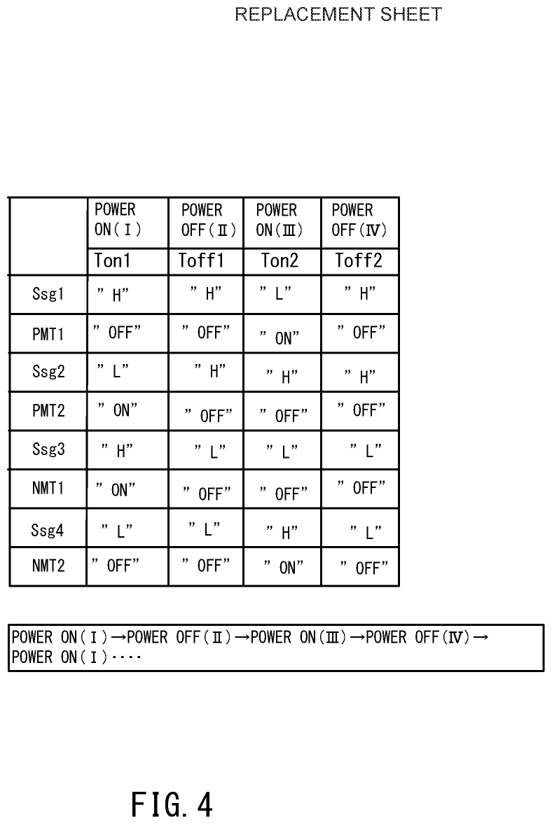

Next, the wireless power feeding mode in the wireless power feeder system 100 will be described with reference to FIGS. 3 and 4. FIG. 3 is a diagram illustrating the wireless power feeding mode. FIG. 4 is a diagram explaining states in the wireless power feeding mode.

As illustrated in FIG. 3, in the wireless power feeding mode with an object 5 set close to the power transmission circuit 1 with a gap Ld in between, the coil 6 (power transmission coil) and the condenser C1 form a serial resonance circuit in the power transmission circuit 1 and feed power (transmit a power signal Spw) to a coil 7 (power reception coil) in the object 5 on the power reception side.

As illustrated in FIG. 4, in the wireless power feeding mode, during power-on (1) which is an on-period (Ton1), the P-channel MOS transistor PMT1 is turned off by the control signal Ssg1 in the disable state (high level). The P-channel MOS transistor PMT2 is turned on by the control signal Ssg2 in the enable state (low level). The N-channel MOS transistor NMT1 is turned on by the control signal Ssg3 in the enable state (high level). The N-channel MOS transistor NMT2 is turned off by the control signal Ssg4 in the disable state (low level).

During power-off (II) which is an off-period (Toff1), the P-channel MOS transistor PMT1 is turned off by the control signal Ssg1 in the disable state (high level). The P-channel MOS transistor PMT2 is turned off by the control signal Ssg2 in the disable state (high level). The N-channel MOS transistor NMT1 is turned off by the control signal Ssg3 in the disable state (low level). The N-channel MOS transistor NMT2 is turned off by the control signal Ssg4 in the disable state (low level).

During power-on (III) which is an on-period. (Ton2), the P-channel MOS transistor PMT1 is turned on by the control signal Ssg1 in the enable state (low level). The P-channel MOS transistor PMT2 is turned off by the control signal Ssg2 in the disable state (high level). The N-channel MOS transistor NMT1 is turned off by the control signal. Ssg3 in the disable state (low level). The N-channel MOS transistor NMT2 is turned on by the control signal Ssg4 in the enable state (high level).

During power-off (IV) which is an off-period (Toff2), the P-channel. MOS transistor PMT1 is turned off by the control signal Ssg1 in the disable state (high level). The P-channel MOS transistor PMT2 is turned off by the control signal Ssg2 in the disable state (high level). The N-channel MOS transistor NMT1 is turned off by the control signal. Ssg3 in the disable state (low level). The N-channel MOS transistor NMT2 is turned off by the control signal Ssg4 in the disable state (low level).

In the wireless power feeding mode, the periods of the power-on (I), the power-off (II), the power-on and the power-off (IV) are repeated in this order. The controller 11 and the driver 12 set the power-on periods and the power-off periods (set the duty periods) to set a suitable power transmission condition for the object 5. As a result, a suitable power is fed to the object 5.

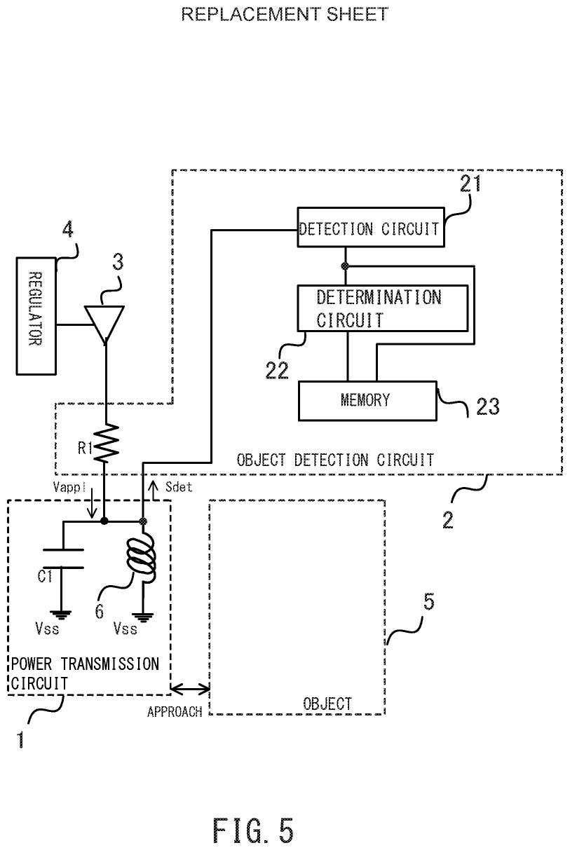

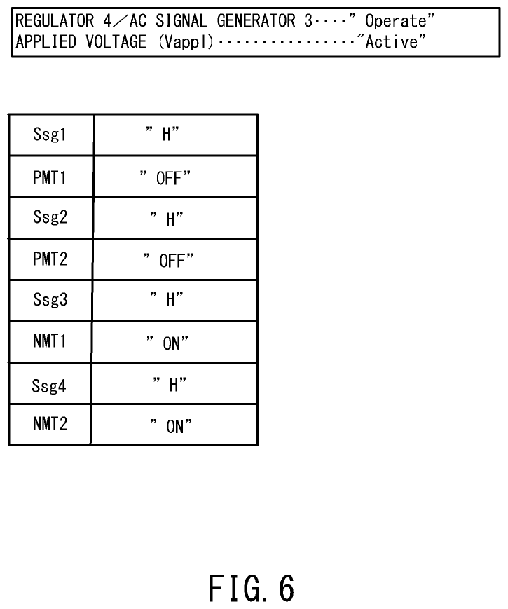

Next, the object determination mode in the wireless power feeder system 100 will be described with reference to FIGS. 5 and 6. FIG. 5 is a diagram illustrating the object determination mode. FIG. 6 is a diagram explaining a state in the object determination mode.

As illustrated in FIG. 5, in the object determination mode, the regulator 4 generates a constant voltage and supplies the constant voltage to the AC signal generator 3. The AC signal generator 3 generates an AC signal to scan the peak of the resonance circuit on the basis of the constant voltage supplied from the regulator 4.

In the object determination mode, the coil 6 (power transmission coil) and the condenser C1, provided in the power transmission circuit 1, form a parallel resonance circuit. The coil 6 is connected at the one end to the one end of the condenser C1, and connected at the other end to the ground potential Vss. The condenser C1 is connected at other end to the ground potential Vss.

The resistor R1, provided in the object detection circuit 2, is provided between the AC signal generator 3 and the coil 6 (power transmission coil). In order to read peak voltage during the object determination mode, the resistor R1 performs I-V conversion and applies an applied voltage Vappl to the one end of the coil. 6 (power transmission coil).

In the object determination mode, as illustrated in FIG. 6, the P-channel. MOS transistor PMT1 is turned off by the control signal Ssg1 in the disable state (high level). The P-channel MOS transistor PMT2 is turned off by the control signal Ssg2 in the disable state (high level). The N-channel MOS transistor NMT1 is turned on by the control signal Ssg3 in the enable state (high level). The N-channel MOS transistor NMT2 is turned on by the control signal Ssg4 in the enable state (high level). As a result, power is not fed to the parallel resonance circuit, formed of the coil 6 (power transmission coil) and the condenser C1, from the driver 12.

In the object determination mode, as the AC signal generator 3 generates an AC signal, a voltage corresponding to the impedance of the parallel resonance circuit is generated across the coil 6 (power transmission coil).

In a state where an object (e.g., a receiver or a metallic object) is not set close to the coil 6, a peak voltage Vpeak appears around the resonance frequency A resonance frequency f₀ is expressed as

f₀=1/{2π(LC)^{1/2}} Equation 1

wherein L is the inductance of the coil 6, and C is the capacitance of the condenser C1.
The inductance L is expressed as

L=k×pe×N² Equation 2

wherein k is a constant, pe is the effective magnetic permeability, and N is the number of turns of wire. The Q factor is expressed as

Q=(2π×f×L)/rs Equation 3

where f is a frequency, L is the inductance, and rs is the effective resistance at the frequency f.

In the object determination mode, in a state where the object 5 (such as a receiver or a metallic object, for example) is set close to the coil 6, a peak voltage Vpeak appears at a frequency different from the frequency at which a peak voltage appears in the state where the object 5 is not set close to the coil 6. The peak voltage Vpeak is a voltage different from the peak voltage that appears in the state where the object 5 is not set close to the coil 6. Thus, it is possible to determine and estimate an object set close to the coil 6 from the difference between the peak voltage in the state where the object is close to the coil 6 and the peak voltage in the state where the object is not close to the coil 6 and the difference between the frequencies at which the respective peak voltages appear.

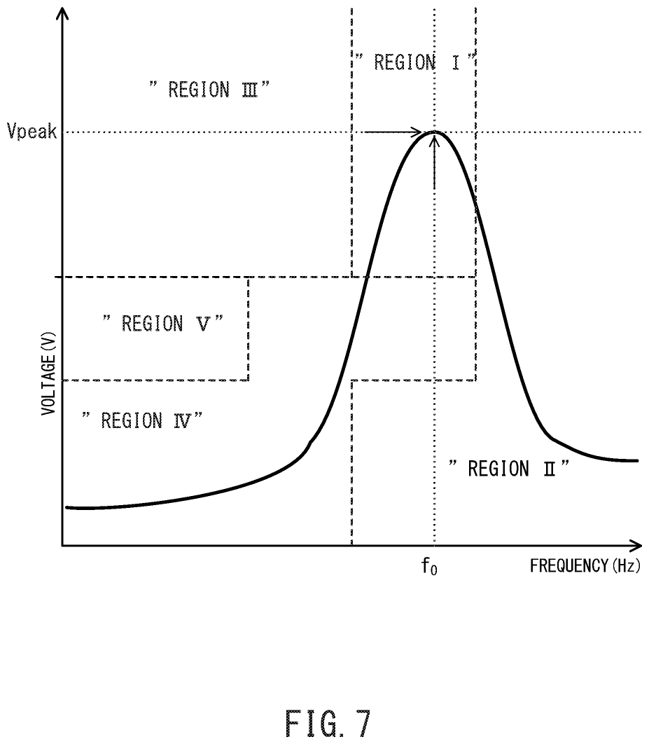

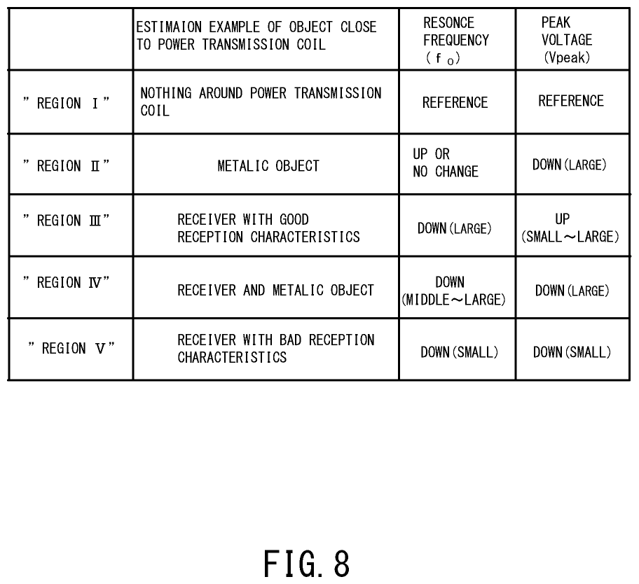

Determination of an object through classification in the object determination mode will be described with reference to FIGS. 7 and 8. FIG. 7 is a diagram explaining a two-dimensional coordinate representation of an object. FIG. 8 is a diagram explaining the resonance frequencies and peak voltages with objects relative to references. In FIG. 8, the relation between the peak voltage Vpeak and the resonance frequency f₀ with the object 5 calculated from characteristics of the detected voltage and frequency is classified by categorizing the relation into one of five regions (“region I” to “region. V”).

The “region I” to “region V” will be described using equations 1 to 3 and FIGS. 7 and 8.

In the case of the “region I” (reference state), in which nothing is around the coil 6 (power transmission coil), the peak voltage Vpeak appears at the resonance frequency f₀, calculated from equation 1 (see the characteristic illustrated by a solid line in FIG. 7).

In the case of the “region II”, in which an electrically conductive metallic object or the like is set close to the coil 6 (power transmission coil), eddy current is generated in the metallic object by lines of magnetic force generated around the coil 6 (power transmission coil), so that a current loss occurs. Consequently, the reactance component increases, so that the Q factor drops and the peak voltage Vpeak drops as well (see equation 3). The generation of the eddy current in the metallic object results in an effect of canceling out lines of magnetic force occurs and therefore an effect equivalent to reducing the number of turns N occurs, so that the value of the inductance L drops (see equation 2). As the value of the inductance L drops, the resonance frequency f₀ rises (see equation 1).

In the case of the “region III”, in which a receiver with good characteristics is set close to the coil 6 (power transmission coil), a magnetic shield (ferrite, for example) is attached to the back surface of the coil 7 (power reception coil) in the receiver in order to shield a circuit board in the receiver from the lines of magnetic force form the power transmission coil 6. When the receiver reaches a state where the ferrite transmits the lines of magnetic force from the power transmission coil 6, an effect equivalent to increasing the number of turns N of the coil occurs, so that the value of the inductance L rises (see equation 2). As the value of the inductance L rises, the resonance frequency f₀ drops (see equation 1). As the Q factor rises, the peak voltage Vpeak rises as well (see equation 3). In the case of the receiver, it is possible to determine the object 5 from the characteristic change caused by the ferrite provided on the back surface of the coil 7 (power reception coil).

In the case of the “region IV”, in which a receiver and a metallic object are set close to the coil 6 (power transmission coil), the original receiver characteristics (“region III”) and the metallic object characteristics (“region II”) are present at the same time, so that the resonance frequency f₀ drops and the peak voltage Vpeak drops as well.

In the case of the “region V”, in which a receiver with bad characteristics is close to the coil 6 (power transmission coil), the receiver is built in a small and thin terminal, such as a smartphone, and it is therefore difficult to make the magnetic shield thick. A metallic object such as a battery is disposed on the back surface of the receiver, thereby making it difficult to achieve a sufficient shield effect. Hence, the “region V” is affected by the original receiver characteristics (“region III”) and the metallic object characteristics (“region II”) to a smaller extent than the “region. IV”, in which a receiver and a metallic object are set close to the coil 6 (power transmission coil).

The detection circuit 21 is provided between the coil 6 (power transmission coil) and each of the determination circuit 22 and the memory 23. In the object determination mode, the detection circuit 21 detects a detected signal Sdet detected at the one end of the coil 6 (power transmission coil). The detected signal Sdet is a signal containing information on the resonance frequency f₀ and the peak voltage Vpeak detected by scanning the detected voltage and frequency.

The information on the resonance frequency f₀ and the peak voltage Vpeak detected by the detection circuit 21 is classified into one of the five regions “region I” to “region V” and stored in the memory 23 under the corresponding region. The memory 23 stores information on power feeding conditions for objects 5 classified into the regions, information on the materials of the objects 5 estimated from the respective resonance frequencies f₀ and peak voltages Vpeak, and so on. A non-volatile memory (such as a magnetoresistive memory, a resistance change memory, or a NAND flash memory, for example), and a volatile memory (such as a dynamic random access memory (DRAM) or a static random access memory (SRAM), for example) are usable as the memory 23.

The determination circuit 22 receives the information on the resonance frequency f₀ and the peak voltage Vpeak with the object 5 detected by the detection circuit 21. The determination circuit 22 determines the object 5 on the basis of the information on the resonance frequency f₀ and the peak voltage Vpeak with the object 5 and information stored in the memory 23 (information on the reference state, in which nothing is set close to the coil 6 (power transmission coil)). On the basis of the result of the determination of the object 5, the determination circuit 22 transmits a suitable power condition for the object 5 in the form of the power change signal Spwh to the controller 11 when the power condition needs to be changed.

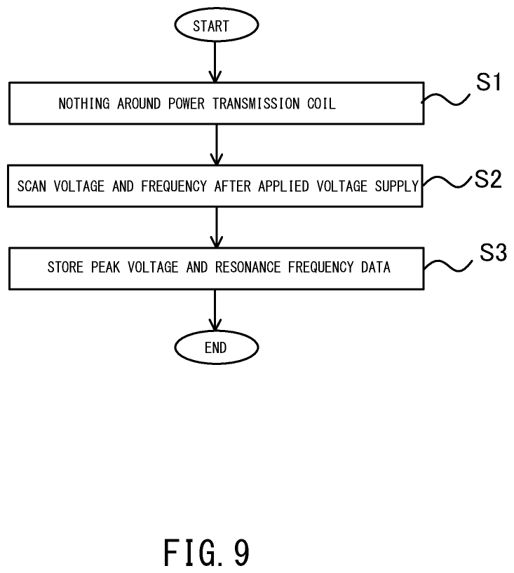

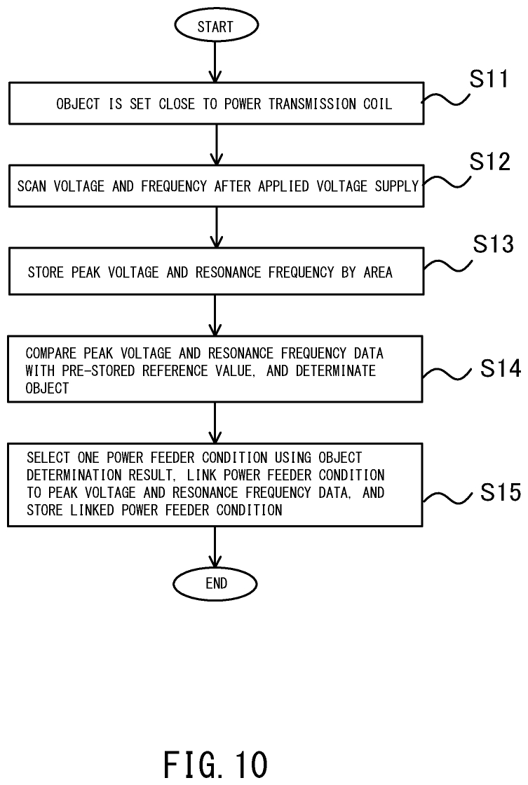

Next, the flow of operation in the object determination mode will be described with reference to FIGS. 9 and 10. FIG. 9 is a flowchart illustrating a process of acquiring reference data. FIG. 10 is a flowchart illustrating a process of detecting an object.

As illustrated in FIG. 9, a state where nothing is set close to the coil 6 (power transmission coil) is prepared (step S1). Then, the applied voltage Vappl is supplied to the one end of the coil 6 (power transmission coil) through the resistor R1 and the voltage and frequency are scanned (step S2). Thereafter, the detection circuit 21 detects the resonance frequency f₀ and the peak voltage Vpeak. The determination circuit 22 checks whether the resonance frequency f₀ and the peak voltage Vpeak are in the “region I”. The memory 23 stores the information on the state where nothing is set close to the coil 6 (power transmission coil) checked by the determination circuit 22 (step S3).

As illustrated in FIG. 10, the object 5 is set close to the coil 6 (power transmission coil) (step S11). Then, the applied voltage Vappl is supplied to the one end of the coil 6 (power transmission coil) through the resistor R1 and the voltage and frequency are scanned (step S12).

Thereafter, the detection circuit 21 detects the resonance frequency f₀ and the peak voltage Vpeak. The determination circuit 22 checks which one of the regions (“region “I” to “region V”) the resonance frequency f₀ and the peak voltage Vpeak with the object 5 are in. The determination circuit 22 determines the object 5 by comparing the reference values stored in advance in the memory 23 (the information on the “region I”, representing in the state where nothing is set close to the coil 6 (power transmission coil)) and the resonance frequency f₀ and the peak voltage Vpeak with the object 5. The memory 23 stores information on the resonance frequency f₀ and the peak voltage Vpeak with the object 5, information on the determination of the region for the object 5, and information on the determination of the object 5 (step S14).

On the basis of the result of the determination of the object 5, the determination circuit 22 selects a suitable power feeding condition for the object 5 from among the pieces of information on the power feeding conditions stored in the memory 23. The memory 23 stores the information on the resonance frequency f₀ and the peak voltage Vpeak with the object 5 in association with the power feeding condition (step S15).

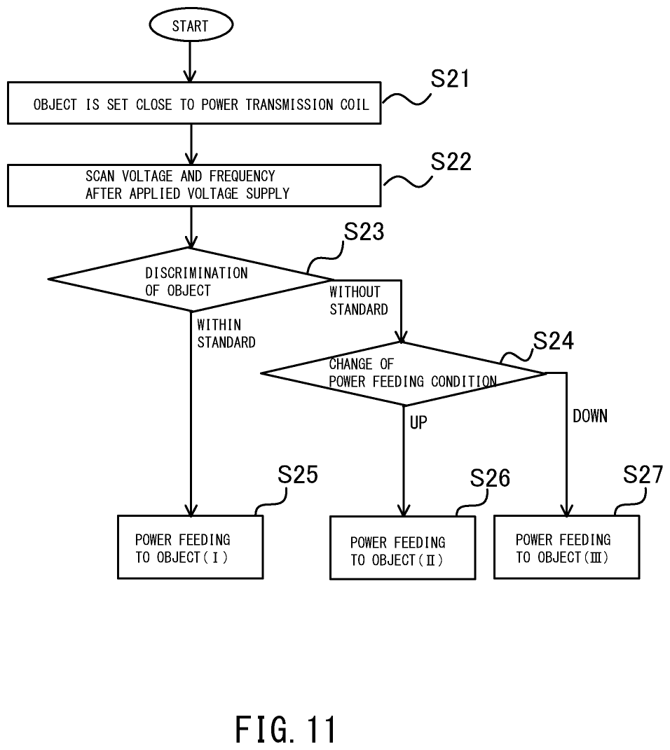

Next, a process of feeding power to an object will be described with reference to FIG. 11. FIG. 11 is a flowchart illustrating the process of feeding power to an object.

As illustrated in FIG. 11, the object 5 is set close to the coil 6 (power transmission coil) (step S21). Then, the applied voltage Vappl is supplied to the one end of the coil 6 (power transmission coil) through the resistor R1 and the voltage and frequency are scanned (step S22).

Thereafter, the detection circuit 21 detects the resonance frequency f₀ and the peak voltage Vpeak. The determination circuit 22 determines the object 5 on the basis of the resonance frequency f₀ and the peak voltage Vpeak with the object 5 (step S23).

When it is determined that the object 5 is a receiver with good characteristics in the “region III” and sufficiently satisfies a wireless power transfer standard (such as a wireless power transfer (WPT) standard or a Qi standard, for example), power feeding (I) to the object is executed using a wireless power transfer standard condition stored in the memory 23 (step S25).

When the object 5 is determined as a receiver not satisfying the wireless power transfer standard, how to change the power feeding condition (whether to raise or lower the power condition) is determined (step S24).

When the object 5 is a receiver with bad characteristics in the “region V”, for example, the determination circuit 22 transmits the power change signal. Spwh (to raise the power condition) to the controller 11 on the basis of the resonance frequency f₀ and the peak voltage Vpeak with the object 5 and the power feeding condition in the memory 23 corresponding to the information on the resonance frequency f₀ and the peak voltage Vpeak. On the basis of the power change signal Spwh, the controller 11 and the driver 12 execute power feeding (II) to the object by using power with the raised power feeding condition. As a result, the power feeding time is shortened (step S26).

When the object 5 is a receiver with a metallic foreign matter (such as metallic tape, for example) in the “region II” for example, the determination circuit 22 transmits the power change signal Spwh (to lower the power condition) to the controller 11 on the basis of the resonance frequency f₀ and the peak voltage Vpeak with the object 5 and the power feeding condition corresponding to the information on the resonance frequency f₀ and the peak voltage Vpeak stored in the memory 23. On the basis of the power change signal Spwh, the controller 11 and the driver 12 execute power feeding (III) to the object by using power with the lowered power feeding condition. As a result; the power feeding is reduced and the power feeding time is lengthened, thus making it possible to prevent heat generation and breakage of the object 5 (step S27).

As described above, the wireless power feeder system 100 in the embodiment includes the power transmission circuit 1, the object detection circuit 2, the AC signal generator 3, and the regulator 4. The wireless power feeder system 100 has the wireless power feeding mode and the object determination mode. In the wireless power feeding mode, the power transmission circuit 1 forms a serial resonance circuit to transmit a power signal to an object on the power reception side. In the object determination mode, the power transmission circuit 1 forms a parallel resonance circuit, and the applied voltage Vappl is supplied to the coil 6 (power transmission coil) in the parallel resonance circuit from the AC signal generator 3 through the resistor R1. As the applied voltage Vappl is supplied, the object detection circuit 2 detects the peak voltage Vpeak and the resonance frequency f₀ on the basis of the detected signal Sdet detected from the coil 6 (power transmission coil) in the parallel resonance circuit. The relation between the peak voltage Vpeak and the resonance frequency f₀ is classified into one of the five regions (“region. I” to “region. V”) to determine the object 5. Power is fed to the object 5 with a suitable power feeding condition on the basis of the result of the determination of the object 5.

Hence, suitable power feeding conditions are always provided to various objects; thereby improving convenience for the users of the objects.

Note that although the relation between the resonance frequency f₀ and the peak voltage Vpeak with the object 5 is classified into one of five regions (“region I” to “region V”) in the first embodiment, the number of regions does not necessarily have to be limited to five. The relation may be classified into one of two to four regions or six or more regions, for example.

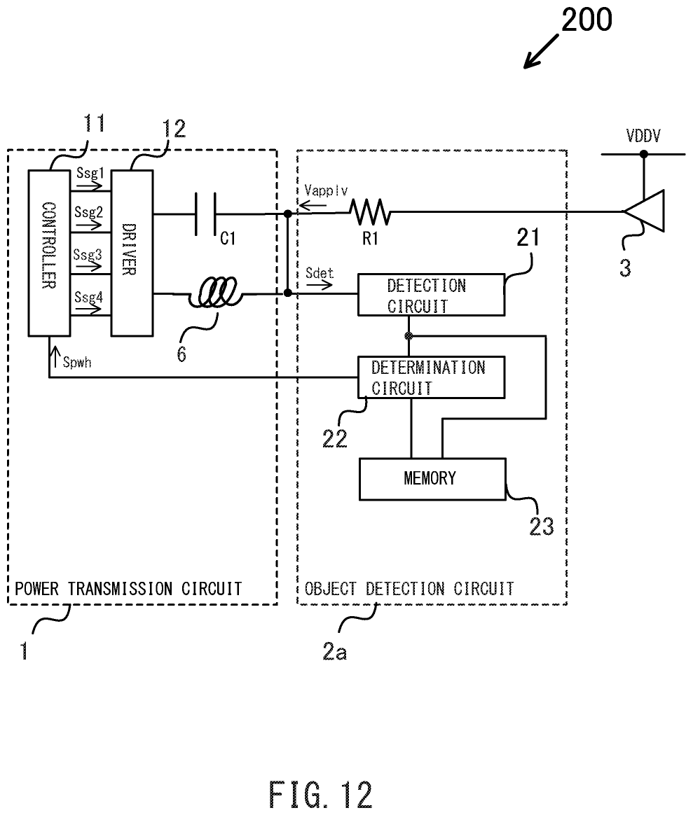

A wireless power feeder system 200 according to a second embodiment will be described with reference to drawings. FIG. 12 is a circuit diagram illustrating the wireless power feeder system 200.

In an object determination mode in the second embodiment, a power transmission circuit forms a parallel resonance circuit, and an applied voltage is supplied to a power transmission coil in the parallel resonance circuit from an AC signal generator through a resistor. When the applied voltage in the object detection and the applied voltage in the acquisition of the reference values are not equal, the applied voltage in the object detection is corrected. After the correction, the object detection circuit classifies and determines the object on the basis of a detected voltage detected from the power transmission coil in the parallel resonance circuit.

In the following, identical constituent portions to those in the first embodiment are designated by identical reference signs, and description of the portions is omitted. Only different portions will be described.

As illustrated in FIG. 12, the wireless power feeder system 200 includes the power transmission circuit 1, an object detection circuit 2a, and the AC signal generator 3. The wireless power feeder system 200 is for indoor and outdoor use and is used in a consumer device, an industrial device, or the like. The wireless power feeder system 200 has a wireless power feeding mode and an object determination mode.

A voltage is supplied to the AC signal generator 3 from a power supply VDDV provided outside the system. In the second embodiment, an applied voltage Vapplv outputted from the AC signal generator 3 through the resistor R1 is assumed to vary due to change in voltage of the power supply VDDV caused by switching of the power transmission circuit 1 (base station) to a high-speed power feeding mode.

In the object determination mode, the AC signal generator 3 generates an AC signal to scan the peak of the resonance circuit on the basis of the varying voltage supplied from the power supply VDDV Thus, the peak voltage Vpeak detected by the detection circuit 21 is varied by the applied voltage Vapplv.

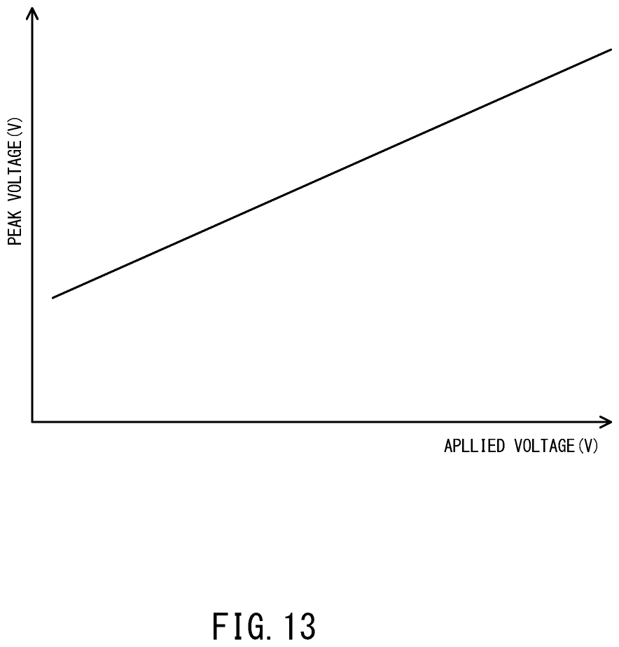

FIG. 13 is a diagram illustrating a relation between the applied voltage and the peak voltage. As illustrated in FIG. 13, with the applied voltage Vapplv on the horizontal axis and the peak voltage Vpeak on the vertical axis, the relation between the applied voltage Vapplv and the peak voltage Vpeak is expressed as

y=ax+b Equation 4

where a is a slope, and b is the value of y when the applied voltage Vapplv is 0 (zero). Using the equation (equation 4) enables correction of the variation of the peak voltage Vpeak caused by the variation of the applied voltage Vapplv.

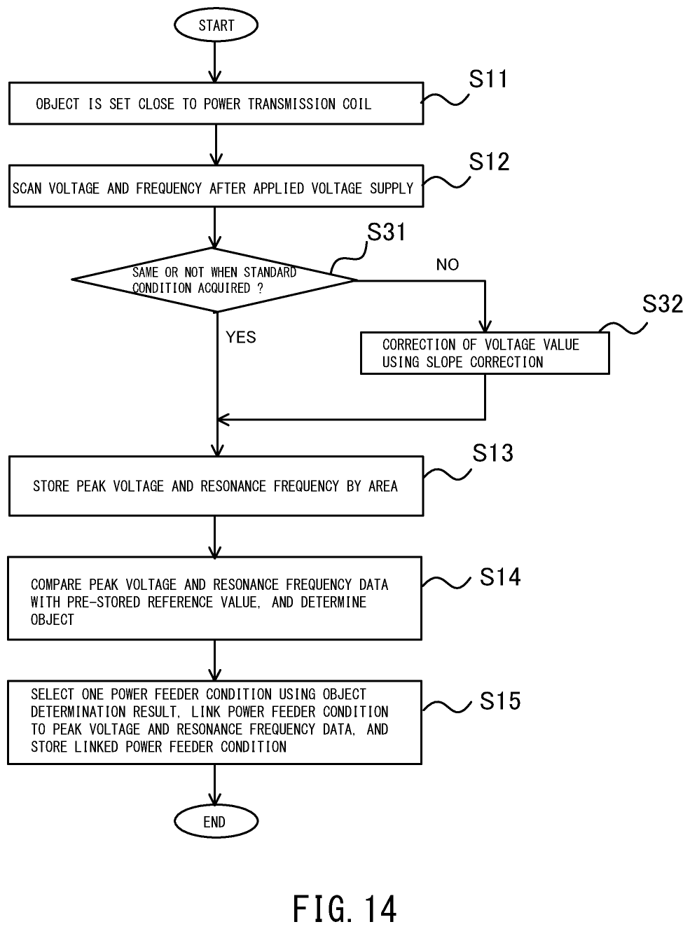

Next, a process of detecting an object will be described with reference to FIG. 14. FIG. 14 is a flowchart illustrating the process of detecting an object. Note that a process of acquiring reference data is similar to that in the first embodiment (see FIG. 9), and description of the process is therefore omitted.

As illustrated in FIG. 14, as in the first embodiment (see FIG. 10), an object 5 is set close to the coil 6 (power transmission coil) (step S11). Then, the applied voltage Vapplv is supplied to the one end of the coil 6 (power transmission coil) through the resistor R1 and the voltage and frequency are scanned (step S12).

Thereafter, the detection circuit 21 detects the resonance frequency f₀, the peak voltage Vpeak, and the applied voltage Vapplv. It is determined whether the applied voltage Vapplv outputted from the AC signal generator 3 through the resistor R1 in the object detection and the applied voltage Vapplv outputted from the AC signal generator 3 through the resistor R1 in the acquisition of the reference values are equal (step S31).

When the voltages are equal, the processes in steps S13 to S15 are performed, as in the first embodiment (see FIG. 10).

When the voltages are different, the peak voltage Vpeak in the object detection is corrected using the linear correction equation described in equation 4 (step S32). After correcting the peak voltage Vpeak, the processes in steps S13 to S15 are performed, as in the first embodiment (see FIG. 10).

As described above, the wireless power feeder system 200 in the embodiment includes the power transmission circuit 1, the object detection circuit 2a, and the AC signal generator 3. In the object determination mode, the AC signal generator 3 generates an AC signal to scan the peak of the resonance circuit on the basis of the varying voltage supplied from the power supply VDDV. The peak voltage Vpeak in the object detection is corrected using a linear correction equation when the applied voltage V apply outputted from the AC signal generator 3 through the resistor R1 in the object detection and the applied voltage Vapplv outputted from the AC signal generator 3 through the resistor R1 in the acquisition of the reference values are not equal.

Hence, even when the voltage from the power supply VDDV varies, the region for the relation between the resonance frequency f₀ and the peak voltage Vpeak is determined accurately, and therefore a suitable power feeding condition for the object 5 is selected. Also, unlike the wireless power feeder system 100 in the first embodiment, the regulator 4 is omitted in the wireless power feeder system 200.

While certain embodiments have been described, these embodiments have been presented by way of example only, and are not intend to limit the scope of the inventions. Indeed, the novel embodiments described herein may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless power feeder system comprising:
a power transmission circuit configured to form a serial resonance circuit to feed power to an object during a wireless power feeding mode to wirelessly feed power to the object, and to form a parallel resonance circuit during an object determination mode, the power transmission circuit including a power transmission coil and a condenser; and
an object detection circuit configured to operate during the object determination mode by supplying an applied voltage to the power transmission coil, the object detection circuit including a detection circuit and a determination circuit,
wherein the detection circuit receives a detected signal outputted from the power transmission coil, calculates a peak voltage and a resonance frequency by scanning voltage and frequency of the detected signal, and classifies information on the peak voltage and the resonance frequency into one of a plurality of regions, and
the determination circuit determines the object by comparing information on a reference state where nothing is set close to the power transmission coil and the information on the peak voltage and the resonance frequency classified with the object.

2. The wireless power feeder system according to claim 1, wherein the object detection circuit includes a memory to store the information on the reference state and the information on the peak voltage and the resonance frequency classified with the object.

3. The wireless power feeder system according to claim 1, further comprising
an AC signal generator; and
a resistor,
wherein in the object determination mode, an AC signal generated by the AC signal generator undergoes 1-V conversion at the resistor, and a resultant applied voltage is applied to one end of the power transmission coil.

4. The wireless power feeder system according to claim 3, wherein in the object determination mode, the AC signal generator receives a varying voltage from a power supply, and variation of the peak voltage caused by the variation of the applied voltage is corrected.

5. The wireless power feeder system according to claim 1, wherein
the power transmission circuit includes a controller and a driver,
the controller generates first to fourth control signals,
the driver includes first to fourth transistors,
the first transistor includes one end connected to a power supply, a control terminal to receive the first control signal, and other end connected to one end of the condenser,
the second transistor includes one end connected to the power supply, a control terminal to receive the second control signal, and other end connected to one end of the power transmission coil,
the third transistor includes one end connected to the other end of the first transistor, a control terminal to receive the third control signal, and other end connected to a ground potential, and
the fourth transistor includes one end connected to the other end of the second transistor, a control terminal to receive the fourth control signal, and other end connected to the ground potential.

6. The wireless power feeder system according to claim 5, wherein in the object determination mode,
the first transistor is turned off by the first control signal in a disable state,
the second transistor is turned off by the second control signal in a disable state,
the third transistor is turned on by the third control signal in an enable state, and
the fourth transistor is turned on by the fourth control signal in an enable state.

7. The wireless power feeder system according to claim 5, wherein
in the wireless power feeding mode, a first on-period, a first off-period, a second on-period, and a second off-period are repetitively set for the first to fourth transistors,
in the first on-period,
the first transistor is turned off by the first control signal in a disable state,
the second transistor is turned on by the second control signal in an enable state,
the third transistor is turned on by the third control signal in an enable state, and
the fourth transistor is turned off by the fourth control signal in a disable state,
in the second on-period,
the first transistor is turned on by the first control signal in an enable state,
the second transistor is turned off by the second control signal in the disable state,
the third transistor is turned off by the third control signal in a disable state, and
the fourth transistor is turned on by the fourth control signal in an enable state, and
in the first off-period and the second off-period,
the first transistor is turned off by the first control signal in the disable state,
the second transistor is turned off by the second control signal in the disable state,
the third transistor is turned off by the third control signal in the disable state, and
the fourth transistor is turned off by the fourth control signal in the disable state.

8. The wireless power feeder system according to claim 5, wherein
the first transistor and the second transistor are P-channel MOS transistors, and
the third transistor and the fourth transistor are N-channel MOS transistors.

9. The wireless power feeder system according to claim 5, wherein the first to fourth transistors are N-channel MOS transistors.

10. The wireless power feeder system according to claim 1, wherein the object includes a receiver with a power reception circuit, or a metallic object.

11. The wireless power feeder system according to claim 10, wherein the receiver is provided in any one of a sensor device, a mobile device, a wearable device, a household device, a robot, and a power infrastructure system.

12. The wireless power feeder system according to claim 10, wherein in the object determination mode, when the object is determined to be a receiver satisfying a wireless power transfer standard, wireless power feeding to the object is executed using a wireless power transfer standard condition stored in the memory.

13. The wireless power feeder system according to claim 12, wherein the wireless power transfer standard is a wireless power transfer (WPT) standard or a Qi standard.

14. The wireless power feeder system according to claim 10, wherein in the object determination mode, when the object is determined to be a receiver not satisfying a wireless power transfer standard, a power feeding condition is changed and then wireless power feeding to the object is executed.

15. The wireless power feeder system according to claim 1, wherein the power transmission circuit is provided in a base station.

16. The wireless power feeder system according to claim 1, wherein the object detection circuit is provided in a microcontroller.
